(19) United States
(12) Patent Application Publication
(10) Pub. No.: US 2015/0017296 A1
(43) Pub. Date: Jan. 15, 2015

(54) METHOD AND APPARATUS FOR CONTROLLING THE ATMOSPHERE IN A SPACE FILLED WITH AGRICULTURAL OR HORTICULTURAL PRODUCTS

(71) Applicant: VAN AMERONGEN CONTROLLED ATMOSPHERE TECHNOLOGY B.V., MB Tiel (NL)

(72) Inventor: Rob Henk Veltman, CT Nijmegen (NL)

(21) Appl. No.: 14/380,649

(22) PCT Filed: Feb. 25, 2013
(86) PCT No.: PCT/NL2013/000005

§ 371 Date: Aug. 22, 2014

(30) Foreign Application Priority Data
Feb. 24, 2012 (NL) 2008346

(51) Int. Cl. A23B 7/148

(52) U.S. Cl. CPC A23B 7/148
USPC 426/419; 99/468

(57) ABSTRACT

The invention relates to a method for controlling the atmosphere in a closable space filled with agricultural or horticultural products. The method comprises directly detecting the respiration of the agricultural or horticultural products and adjusting an oxygen content, a carbon dioxide content and/or a nitrogen content in the space subject to the detected respiration. The respiration is detected here periodically, in each case for a determined time, and the space is sealed off from external influences during detection of the respiration. A very good control is achieved by taking the actual respiration as starting point, and a highly reliable detection forms the basis of this control when the detection is performed periodically for some time in a completely isolated atmosphere. The invention also relates to an installation for performing the method, and to a closable space provided with such an installation.

### CROSS-REFERENCE TO RELATED APPLICATIONS

This application is a national phase entry under 35 U.S.C. §371 of International Patent Application PCT/NL2013/000005, filed Feb. 25, 2013, designating the United States of America and published in English as International Patent Publication WO 2013/125944 A1 on Aug. 29, 2013, which claims the benefit under Article 8 of the Patent Cooperation Treaty and under 35 U.S.C. §119(e) to The Netherlands Patent Application Serial No. 2008346, filed Feb. 24, 2012, the disclosure of each of which is hereby incorporated herein in its entirety by this reference.

### TECHNICAL FIELD

The invention relates to a method for controlling the atmosphere in a closable space at least partially filled with agricultural or horticultural products by directly detecting the respiration of the agricultural or horticultural products and adjusting an oxygen content, a carbon dioxide content and/or a nitrogen content in the space subject to the detected respiration. Such a method is known from WO 2011/113915 A1.

### BACKGROUND

Proper storage of agricultural and horticultural products is of great importance. Such products are usually harvested only once a year and, in order to maintain a good price level, have to be brought onto the market in a constant supply over a period of time. It is known that agricultural and horticultural products can be stored for a long time if they are stored in a controlled atmosphere (CA). A controlled atmosphere is understood here to mean an atmosphere, with a composition, particularly the oxygen content, the carbon dioxide content and the nitrogen content, which is maintained within precisely determined limits.

The oxygen content is of particularly great importance for a long storage life; this must be kept as low as possible. This is because fresh agricultural and horticultural products exhibit respiration during storage; they take up oxygen from the atmosphere and use it to convert or combust complex molecules such as glucose, wherein energy is released. This respiration is accompanied by ripening of the products, whereby their storage life is limited.

In order to prevent premature ripening, fruit such as, for instance, apples or pears is stored in an atmosphere with a very low oxygen content known as ULO (Ultra-Low Oxygen) storage. For pears, the oxygen content amounts to, for instance, 2-3 percent, while for apples, it even amounts to less, i.e., 0.8-1.5 percent.

Although a reduction of the oxygen content results in principle in a longer storage life, there are limits to the possible reduction. This is because there is a risk, if the oxygen content becomes too low, of respiration or aerobic respiration transposing into fermentation, or anaerobic respiration. In fermentation, which can be seen as “emergency respiration” of the products, glucose is converted into carbon dioxide and, in the case of fresh horticultural products, alcohol. If fermentation continues for too long, it results in damage to the products, whereby they become unsaleable.

Despite this risk, there is, nevertheless, a need in the case of some agricultural and horticultural products for a further reduction in the oxygen content at which the products are stored. This is dictated mainly by the wish to prevent storage defects. Chemical agents have heretofore usually been used for this purpose, but the use hereof is increasingly being called into question. Apples and pears, for instance, are currently still treated with DPA (diphenylamine) after being picked so as to prevent scald, a peel disorder in which black discolorations occur, which render the fruit worthless. The use of this agent has, however, been prohibited in Europe since 2012.

In order to enable further reduction of the oxygen content at which fruit is stored, it is necessary that the transition from respiration to fermentation can be clearly determined so that timely measures can be taken to prevent product damage.

Different methods are already known for timely detection of the occurrence of fermentation.

A first method is based on measurement of the alcohol formed during the fermentation. In this known method, samples of the fruit stored in a storage space are taken periodically, for instance, weekly. These samples, which can, for instance, consist of a few apples or pears, are analyzed in a laboratory where the ethanol content in the flesh is determined by chemical analysis. A problem of this known method is that it depends on the proximity of a well-equipped laboratory, while the labor and the transport of the samples are time-consuming and expensive. Because alcohol measurements cannot, in practice, be performed in the storage space itself, this method is not suitable for implementation in a measuring and control system connected to the space.

Another known method is described in “The harvest watch system —measuring fruit's healthy glow,” B. E. Stephens and D. J. Tanner, ISHS Acta Horticulturae 687: International Conference Postharvest Unlimited Downunder 2004. This is based on measuring the fluorescence of the chlorophyll in the peel, which would be an indicator of the state of health of the fruit, particularly the amount of chlorophyll. The method is based on illuminating a sample of the stored fruit and deriving the risk of fermentation from the measured fluorescence. The relation between the detected fluorescence of the peel and the occurrence of fermentation is, however, found not to be unambiguous in practice, whereby this method is not wholly reliable.

The stated document WO 2011/113915 A1 describes a method and a system for ULO storage of fruit or other produce, particularly apples, wherein continuous measurement takes place of the change in the oxygen and carbon dioxide content in the storage space in order to derive therefrom the respiratory activity of the stored fruit. On the basis of this respiratory activity, and taking into account the effect of leakages in the storage space, the atmosphere in the space is then continuously controlled by supplying oxygen when the value of a parameter GERQ (gas exchange rate quotient) changes. The known method is found to be particularly suitable for use under laboratory conditions, since it is not easily possible in practice to continuously measure and control the respiration of fruit in a conditioned storage space.

### DISCLOSURE

Therefore, there exists a need for a practical method with which the atmosphere in a closable storage space for agricultural or horticultural products can be controlled in a reliable manner such that the risk of fermentation, even at very low oxygen levels, can be substantially wholly precluded. According to the invention, this is achieved in that the respiration is detected periodically, in each case for a determined time, and the space is sealed off from external influences during detection of the respiration. By taking the actual respiration as a starting point, a better control is achieved than would be possible on the basis of previous test results or theoretical models. The periodic detection for some time in a completely isolated atmosphere also makes it possible to measure small differences in oxygen and carbon dioxide content in a reliable manner. The “accumulation” of respiratory products, particularly carbon dioxide, is then as it was measured.

In order to obtain a more reliable picture of the state of the products without the measurements disrupting the storage process, the respiration can be detected for at least one hour at a time, preferably for several hours. A properly measurable “accumulation” of carbon dioxide and a properly measurable decrease in the oxygen concentration are thus obtained.

For a reliable detection, an adjusting apparatus for the oxygen content, the carbon dioxide content and/or the nitrogen content, which is connected to the space, can advantageously be switched off during detection of the respiration. Adjusting means for the temperature connected to the space are preferably also switched off during detection of the respiration.

The reliability of the detection is further improved when the space is made substantially completely leakage-tight, at least during detection of the respiration. In order to prevent oxygen-rich ambient air from penetrating the space through possible remaining small leaks, whereby the detection would be disrupted, the space is preferably brought to a higher pressure than the surrounding area prior to detection of the respiration. This can take place in a simple manner by injecting a quantity of gas, for instance, nitrogen.

When the atmosphere in the space is set into or kept in motion during detection of the respiration, the respiratory products are distributed uniformly through the space so that a more reliable detection is achieved.

During a measurement, which generally takes a number of hours, all conditioning equipment can thus be switched off, with the possible exception of the ventilation and the cooling cell as if it were “shut down.” All that then takes place is the measurement at fixed times of the temperature and the gas conditions in the cooling cell.

In order to minimize the measurement and control efforts, it is recommended that days or even weeks pass between successive detections. Once a low-oxygen atmosphere has been set, the state of the stored produce only changes slowly, so that it is still possible to take timely action with such a periodic measurement if there is imminent danger of fermentation.

A simple control is obtained when the respiration of the agricultural or horticultural produce is detected by measuring their oxygen absorption, measuring their carbon dioxide release and determining the ratio thereof, and the oxygen content in the space is decreased as long as the thus determined ratio remains substantially constant. A measure for this ratio is the so-called respiratory quotient (RQ), defined as the quotient of the carbon dioxide formed by the respiration and the oxygen consumed:

RQ=produced CO₂/absorbed O₂ (I)

A constant ratio of oxygen absorption and carbon dioxide release indicates a normal respiration, so that the limit at which fermentation occurs has then apparently not yet been reached. The oxygen content can, in that case, be further reduced, either actively by extracting oxygen from the storage space or passively by not replenishing the oxygen consumed in the respiration.

In order to prevent loss of quality of the stored produce, it is recommended that the oxygen content in the space is increased at least temporarily as soon as the ratio of oxygen absorption and carbon dioxide release changes considerably. Such a change does, after all, indicate fermentation, and this process can be halted and even reversed to a limited extent by increasing the oxygen content in the space.

In order to obtain a good picture of the respiration, a detection preferably comprises a number of measurements of the oxygen absorption and carbon dioxide release. The number of measurements has to be statistically reliable here in order to achieve a reliable control.

The invention also relates to an installation with which the above-described method can be performed. An installation known from WO 2011/113915 A1 for controlling the atmosphere in a closable space at least partially filled with agricultural or horticultural products comprises a controllable apparatus for adjusting an oxygen content, a carbon dioxide content and/or a nitrogen content in the space, a control system connected to this adjusting apparatus and means connected to the control system for directly detecting the respiration of the agricultural or horticultural products.

The installation according to the invention is distinguished from the known installation in that the control system is configured to periodically switch on the respiration detection means for a determined period at a time and to seal off the space from external influences when the respiration detection means are switched on. A reliable “accumulation measurement” of the respiration products can thus be performed.

The control system can advantageously be configured here to keep the respiration detection means switched on for at least one hour at a time, preferably for several hours in succession, in order to achieve sufficient ‘accumulation’ to bring about an easily measurable decrease in the oxygen content and increase in the carbon dioxide content, respectively.

The control system is preferably configured to switch off the adjusting apparatus when the respiration detection means are switched on.

These respiration detection means can preferably comprise at least one oxygen meter and at least one carbon dioxide meter.

The adjusting apparatus can further have means for adjusting a temperature in the space. The CA or ULO storage is most effective at a low temperature, in the order of several degrees above freezing point.

Further preferred embodiments of the installation according to the invention are described in the dependent claims.

Finally, the invention relates to a closable space for storing agricultural or horticultural products in a controlled atmosphere, which can be provided with an installation as described above. According to the invention, such a space has the feature that it is substantially completely leakage-tight, in any case, when the respiration detection means are operating. The space can, for this purpose, then have a leak-tightness of less than 0.2 cm² per 100 m³, preferably less than 0.15 cm² per 100 m³ and more preferably in the order of 0.1 cm² per 100 m³.

### BRIEF DESCRIPTION OF THE DRAWINGS

The invention will now be elucidated on the basis of an embodiment, wherein reference is made to the accompanying drawing, in which:

FIG. 1 is a schematic view of a storage space for agricultural or horticultural products with an installation for controlling the atmosphere according to the invention;

FIG. 2 shows a graph in which the formation of carbon dioxide is shown as a function of the oxygen pressure;

FIG. 3 is a curve showing the progression of the respiratory quotient as a function of the oxygen content in the storage space;

FIG. 4 is a graph showing the measured oxygen absorption and carbon dioxide release of fruit in the storage space; and

FIG. 5 is a schematic view of the progression of a measuring cycle for detecting the respiration of fruit in the storage space.

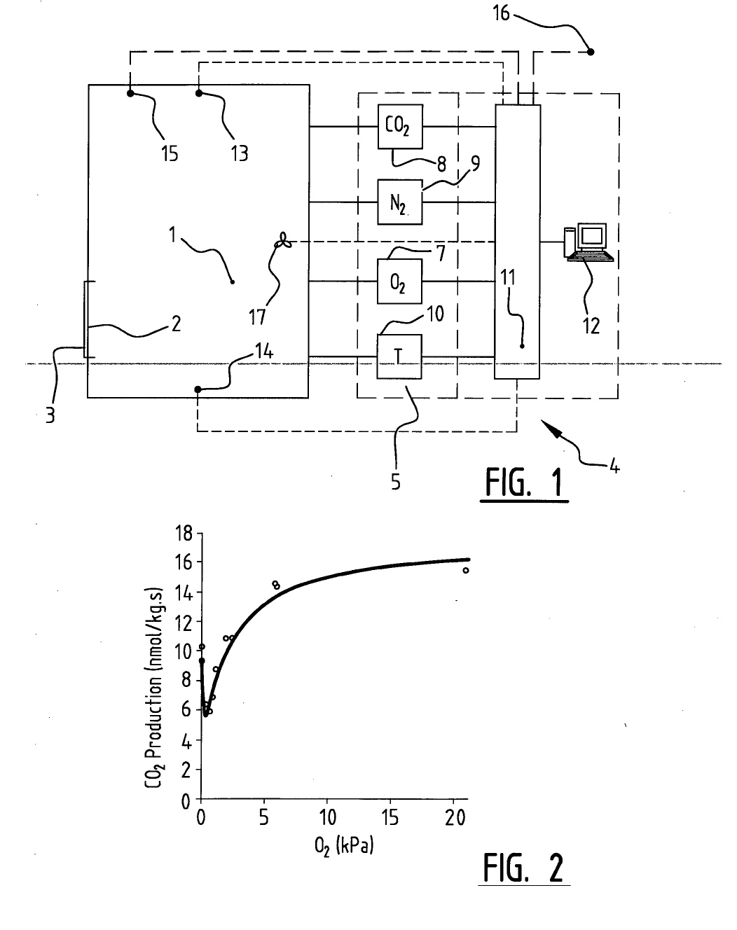

### DETAILED DESCRIPTION

A space 1 for storing agricultural or horticultural products, for instance fruit, is closed on all sides. In practice, this is a space 1 that is suitable for storage of several tens or even hundreds of tons of fruit.

Arranged in one of the walls of space 1 is an opening 2 through which the fruit can be carried into and removed from the space. This opening 2 can be hermetically sealed by a door 3. Connected to space 1 is an installation 4 that controls the atmosphere in space 1. This installation 4 comprises an adjusting apparatus 5 for adjusting the content of oxygen O₂, the content of carbon dioxide CO₂, and the content of nitrogen N₂ in the space and for adjusting the temperature T in space 1. Installation 4 further comprises a control system 6 that is connected to adjusting apparatus 5.

Adjusting apparatus 5 comprises a module 7 for adjusting the oxygen content, such as an oxygen generator, and a module 8 for adjusting the carbon dioxide content. The carbon dioxide module 8 can comprise a so-called CO₂ scrubber. A module 9 for adjusting the nitrogen content, such as a nitrogen generator, also forms part of adjusting apparatus 5. In addition, adjusting apparatus 5 comprises a cooling unit 10 for controlling the temperature in space 1. Installation 4 also comprises means 17 for setting the air in space 1 into motion. These moving means 17, which can also be controlled by control system 6, can, for instance, take the form of one or more fans. Control system 6 comprises a processing unit 11, which is connected in controlling manner to the different modules 7-10, and an input and output unit 12, for instance, in the form of a workstation or PC with screen, keyboard and printer.

Up to this point, the installation 4 is substantially the same as a conventional installation for controlling the atmosphere. The control installation serves to reduce the content of oxygen O₂ as quickly as possible in space 1 as soon as the fruit has been placed in space 1 and this space has been sealed by closing the door 3. This oxygen content amounts to 21 percent in the outside air, and for the storage under CA or ULO conditions, is reduced to 2-3 percent in the case of pears and 0.8-1.5 percent in the case of apples. Control system 6 activates for this purpose the nitrogen module 9, which generates and feeds nitrogen N₂ to space 1, whereby oxygen O₂ is displaced out of space 1. The content of carbon dioxide CO₂ in space 1 is regulated here by the carbon dioxide module or scrubber 8, which removes the carbon dioxide formed by the respiration of the fruit. The cooling 10 is also activated after closing of space 1 in order to reduce the temperature in the space to a value which, depending on the stored product, can vary from −2 to 15° C. The fruit can be stored for the longest period at these low temperatures. This part of the control takes place under the influence of a program that is executed by control system 6 and that can be based on results of previous tests or on theoretical theses.

Control installation 4, according to the invention, is distinguished from conventional installations in the first instance by the presence of an oxygen sensor 13 and a carbon dioxide sensor 14, which in the shown embodiment, are arranged in space 1 and are connected for signal generation to control system 6. Just as the rest of control installation 4, these sensors 13, 14 could otherwise be arranged outside space 1 and connected via sampling lines to space 1. The oxygen absorption and the carbon dioxide release, which together define the respiratory activity of the fruit, can be measured directly using sensors 13, 14. Hereby obtained is a clear picture of the respiration of the fruit, which can function as basis for further control of the composition of the atmosphere in space 1.

Control installation 4 is further provided, according to the invention, with means for setting a determined pressure in space 1. In practice, there must be a slight overpressure in space 1 relative to the surrounding area. Such an overpressure prevents possible leakages resulting in ambient air with a greatly differing composition, in particular, much too high an oxygen content, being able to penetrate into space 1. The pressure adjusting means comprise in the shown embodiment a first pressure gauge 15 in space 1 and a second pressure gauge 16 outside it. Both pressure gauges 15, 16 are connected to processing unit 11 of control system 6, which determines a pressure difference between space 1 and the surrounding area on the basis of the measurement signals. If this pressure difference is too small or even negative, a gas or gas mixture is introduced into space 1 in order to increase the pressure therein. In the shown embodiment, the control system controls the nitrogen generator 9, which introduces nitrogen into space 1 until the pressure therein has been increased sufficiently relative to the ambient pressure.

The operation of the above-described control installation 4 is now as follows.

When the oxygen content in space 1 has been reduced according to the control program to a value usual for CA or ULO storage, the further control of the atmosphere in space 1, and particularly the further reduction of the oxygen content, is carried out on the basis of the actual respiratory activity of the stored fruit detected using the oxygen and carbon dioxide sensors 13, 14. This is referred to by applicant as Dynamic Controlled Respiration (DCR).

It is known that the respiration rate of fruit decreases as the oxygen content in space 1 falls, although this decrease is not linear, as shown in FIG. 2. In this figure, in which the CO₂ production of the fruit is plotted against the oxygen pressure, the drawn points are actual measuring points from practical tests, while the line is a model based on the estimated activity of enzymes involved in the reactions. When the oxygen pressure or the oxygen content in space 1 decreases further, there comes a moment when the CO₂ production will suddenly greatly increase. This is the result of fermentation. The transition point, at which the production of carbon dioxide is minimal, is the anaerobic compensation point ACP.

For the purpose of controlling the atmosphere in space 1, use is made of the ratio of the oxygen absorption and the carbon dioxide release. As stated, this ratio can be expressed in a respiratory quotient RQ:

RQ=produced CO₂/absorbed O₂ (I)

In the case that glucose is combusted, the respiratory quotient RQ=1. This follows from the chemical formula for the respiration:

C₆H₁₂O₆+6O₂=>6CO₂ 6H₂O (II)

Energy is released during the respiration, on the one hand, in the form of ATP (Adenosine Triphosphate, the generic energy carrier in living organisms) and, on the other, as heat.

That the respiratory quotient RQ increases at the transition from respiration to fermentation follows from the fact that, for fermentation purposes, no oxygen is absorbed while carbon dioxide is being produced, as shown from the applicable chemical formula:

C₆H₁₂O₆=>2CO₂2C₂H₅OH (III)

Energy is also released during this conversion, be it considerably less than during respiration.

The transition from respiration to fermentation can be clearly shown on the basis of the respiratory quotient RQ (FIG. 3). The control of the atmosphere in space 1 on the basis of the detected respiration, therefore, consists of the ratio of the oxygen absorption and carbon dioxide release being determined, for instance, by calculating the respiratory quotient RQ, and the oxygen content in space 1 being reduced as long as this ratio remains substantially constant. However, as soon as the ratio is no longer constant but changes distinctly, as indicated in the graph of the respiratory quotient RQ by a sharp bend, the anaerobic compensation point ACP has been reached and the oxygen content in space 1 has to be increased in order to prevent damage to the fruit. Where an RQ value of about 1 is usual, a rise above a value of, for instance, 1.5 is, in principle, risky, so action has to be taken.

In a practical embodiment of installation 4, the control system 6 is programmed to lower the oxygen content by 0.1 percent at a time, as long as the respiratory quotient RQ is less than 1.3. As stated, this can be done actively or passively. When the respiratory quotient has a value lying between 1.3<RQ<1.5, control system 6 is programmed not to influence the oxygen content. However, as soon as the respiratory quotient is detected as rising to RQ>1.5, control system 6 intervenes to increase the oxygen content.

For this purpose, control system 6 switches on the ventilation 7, which introduces oxygen into space 1. The oxygen content need only be increased so much that the normal, aerobic respiration is resumed. Only the most recent state in which respiration was still being detected and wherein the respiratory quotient RQ was thus still constant, need be restored for this purpose. Because control system 6 is configured to store and/or print the measured values, this previous state can be restored in a simple manner so that control system 6 can determine how long ventilation 7 has to remain switched on. It is also possible to increase the oxygen content by a predetermined amount, for instance 0.2 percent at a time.

Reducing the oxygen content, as long as detection indicates that there is respiration but no fermentation, can take place both actively and passively. Active reduction entails control system 6 switching on nitrogen generator 9, while a passive reduction of the oxygen content takes place as a result of the continuing respiratory activities of the fruit.

For a reliable detection of the respiratory activities, it is necessary for all external influences to be removed. To this end, the control system 6 switches off adjusting apparatus 5 completely. Oxygen module 7, carbon dioxide module 8, nitrogen module 9 and cooling 10 are thus deactivated, whereby storage space 1 is, as it were, “shut down.” This happens only after control system 6 has determined that the overpressure in space 1 is sufficient to prevent ambient air penetrating into the space. Should the overpressure be insufficient, it can then be restored by introducing a determined volume of gas, for instance, nitrogen or oxygen. Moving means 17 can remain operational since a mild form of ventilation provides for a certain mixing of the air in the space, whereby the detection can be more precise.

In this situation, the oxygen content and carbon dioxide content are thus no longer determined by adjusting apparatus 5 but solely by the respiratory activities of the stored fruit. Adjusting apparatus 5 can otherwise not remain switched off for too long at a time because the temperature in space 1 then rises too sharply. Practical tests have shown that a detection, which takes several hours, for instance, four hours, need not be a problem. Such a duration is sufficient to achieve an easily measurable “accumulation” of carbon dioxide produced by the fruit and a likewise easily measurable decrease in the oxygen content.

For a reliable detection of the respiration, it is, in addition, necessary for space 1 to be substantially completely leakage-tight. Because the oxygen content in the outside air is 21 percent, only a slight leak would already result in much too high a detection of the oxygen content and thereby in the respiratory quotient RQ being underestimated. In the method according to the invention, higher standards for storage space 1 are, therefore, set than has heretofore been usual for CA or ULO storage. The leak-tightness, therefore, has to be lower than 0.2 cm² per 100 m³, and preferably much lower. Space 1 preferably has leaks with a maximum surface area of 0.15 cm² per 100 m³, and preferably in the order of 0.10 cm² per 100 m³.

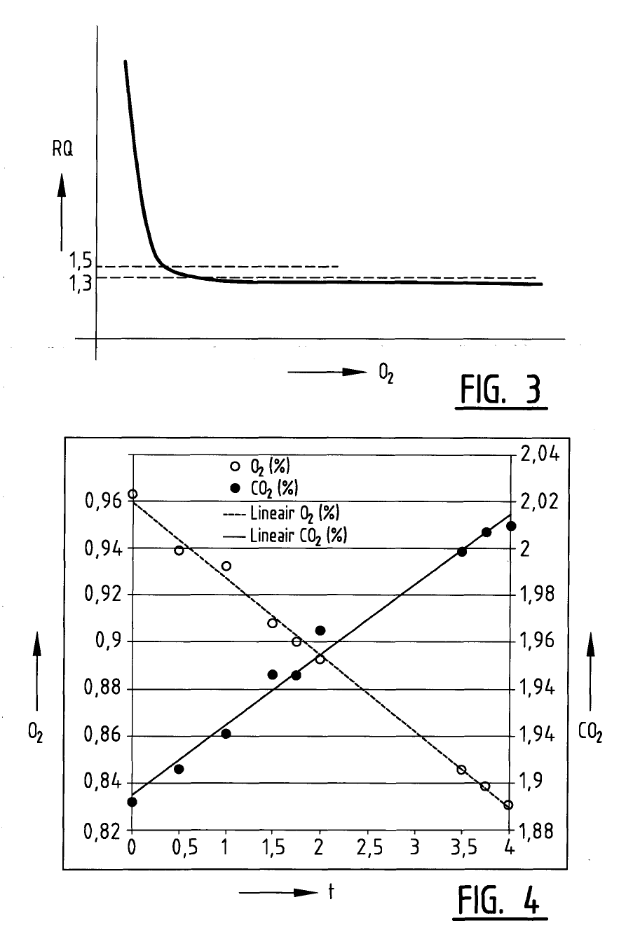

The detection consists of performing measurements at set intervals using oxygen sensor 13 and carbon dioxide sensor 14. FIG. 4 shows that, during a number of hours of detection, there is a substantially linear decrease in the oxygen content in space 1 while there is simultaneously a substantially linear increase in the carbon dioxide content. The respiratory quotient RQ is found in this embodiment to be slightly greater than 1 because not only is glucose combusted as according to formula II, but, for instance, also malate (malic acid), which is first converted to glucose, wherein carbon dioxide is also produced.

The detections are repeated periodically, initially, for instance, every day. The longer the products are stored, the further the frequency at which detection takes place can be reduced, since the changes in the atmosphere in space 1 become increasingly smaller. A detection can then be performed, for instance, once every two or three days, or even once a week.

Although there were nine individual measurements in the test that resulted in FIG. 4, it is probably possible in practice to suffice with- three to five measurements to obtain a reliable detection. FIG. 4 also shows that a valid measurement value is not found at each point in time. The measurements that took place after 2.5 and 3 hours are, thus, not included in the results here because they differed too much from the surrounding and historical measurement values.

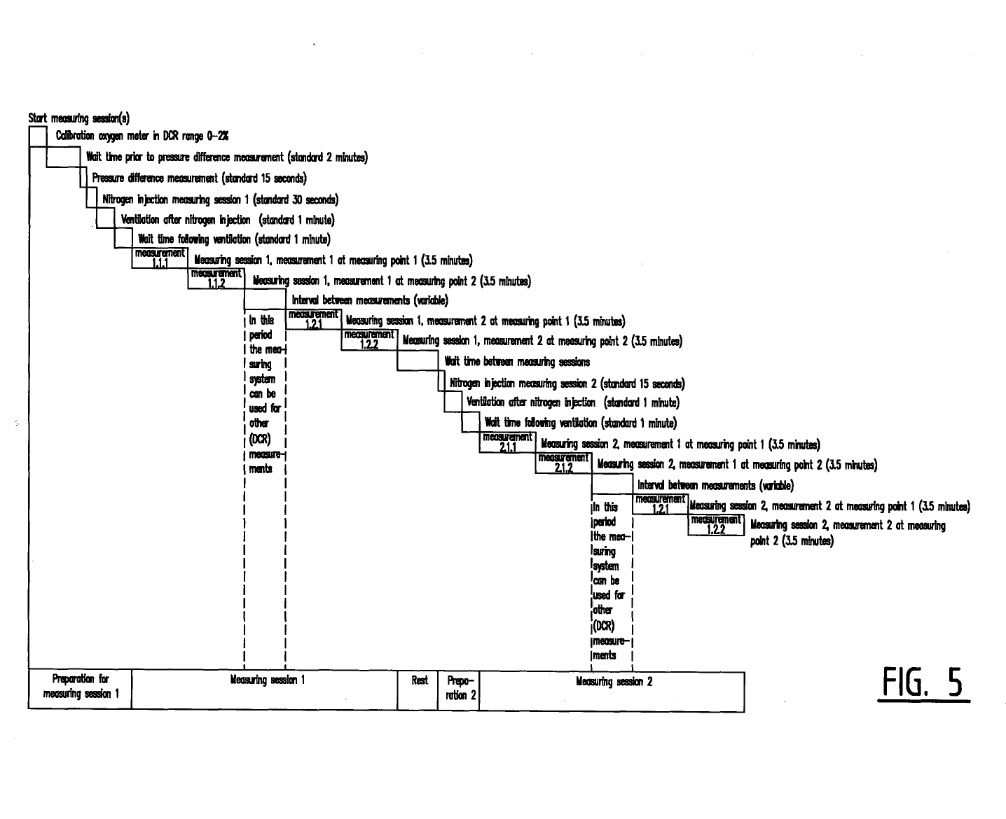

FIG. 5 shows the steps of a typical measuring cycle that can be used in practice. This is based on measurement at two different points in storage space 1 where two measurements are performed in each case at a determined interval.

The first step is calibration of the oxygen meter in the range relevant for the DCR control, i.e., 0 to 2 percent O₂. Adjusting apparatus 5 is then switched off. Only the moving means or fans 17 can continue to operate at a reduced rotation speed for a slight mixing during the measurement. This mixing is not continuous but takes place only when a measurement of the oxygen content and carbon dioxide content is actually being performed. The fans can, for instance, be switched on a minute before the start of a measurement and switched off again immediately after ending of the measurement.

After adjusting apparatus 5 has been switched off, there follows a waiting period, here of two minutes, for the purpose of easing turbulence and equalizing pressure differences in space 1. A measurement is then made of the pressure difference between storage space 1 and the surrounding area. Although not shown in FIG. 5, a temperature measurement can take place simultaneously in space 1. The relative humidity and the ethylene content could optionally also be measured. Nitrogen is then introduced into space 1 in an amount in order to attain a sufficient overpressure. Moving means 17 are then switched on in order to ventilate space 1 and then a waiting period follows, for instance, of a minute.

The first measuring session can then be started by performing a measurement at the first measuring point. This measurement takes 3.5 minutes in the shown example. A measurement is then performed, likewise for 3.5 minutes, at another point in space 1. The first values for the oxygen content and the carbon dioxide content in space 1 are hereby known. There then follows a waiting period before a subsequent measurement is performed. In the example of FIG. 4, the measurements are repeated every half hour so that the waiting time between two sessions amounts, in this example, to 30−2×3.5=23 minutes. During this period, the measuring system can be used for measurements in other storage spaces.

In a subsequent step, measurements are again performed at measuring points 1 and 2, whereby values of the oxygen content and the carbon dioxide content are thus known once again. On the basis of the difference between the measured values, the decrease in the oxygen content and the simultaneous production of carbon dioxide can be determined, and so, therefore, the respiratory quotient RQ. Control system 6 is configured here to disregard measured values varying too much from the expected outcomes. A measurement can thus, for instance, be declared invalid if the difference between the measured values at the one end and the other measuring point exceeds a determined threshold, for instance, if the measured oxygen contents, carbon dioxide contents or the values for the respiratory quotient RQ calculated therefrom differ by more than 10% from each other. Control system 6 can also declare a measurement invalid if the temperature or pressure in space 1, which is monitored continuously during the measuring session, differs too much from the limited values.

In the shown example, the above-described measuring session is repeated once again after a determined waiting period in order to obtain a control measurement. This second measuring session also begins with injection of nitrogen, ventilation and waiting, after which measuring takes place once again at two different points in space 1. These measurements are then repeated again following a determined interval so that two values of oxygen content and carbon dioxide content, from which the respiratory quotient RQ can be calculated, are also known at each measuring point in the control session. It is here also the case that the measured values are only accepted if they do not vary too much from each other and from the expected measured values. The two measuring sessions are also declared invalid if the measurement values of the second measuring session differ greatly from those of the first measuring session.

If the two measuring sessions are indeed valid, the average of the respiratory quotient of the first measuring session and the respiratory quotient of the second measuring session is determined and used as average respiratory quotient RQavg to control the oxygen content in space 1. The average of the starting times of the first and second measuring sessions is used here as time of detection.

Each measuring session can, of course, consist in practice of more than two measurements. As stated, three to five measurements per measuring session will probably be necessary and sufficient for good control of the atmosphere. Each measuring session can last a number of hours (the example of FIG. 4 is based on four hours), and the waiting time between two successive sessions in a single measuring cycle can also amount to a few hours. The time axis in FIG. 5 is, therefore, not to scale.

The invention makes it possible in the above-described manner to adjust the control of the climate in a space filled with agricultural or horticultural products to actually detect respiratory activities of the stored produce. A more reliable control is hereby possible, wherein the oxygen content can be reduced further than is possible according to the prior art. In practical tests, oxygen content of 0.2-0.5 percent have been achieved without fermentation occurring.

Reducing the oxygen content to substantially the theoretical minimum, the anaerobic compensation point ACP, prevents respiration of the products and, therefore, their deterioration, as long as possible. This increases the storage life so that the produce can be brought onto the market gradually over time, whereby a good price can be obtained for them. Applying an oxygen content close to the ACP can, moreover, prevent the occurrence of storage defects, such as, for instance, scald, without having to make use of chemicals for this purpose. Finally, the decrease in the respiration results in a decrease of the heat developing in space 1 so that less cooling capacity is also required, this resulting in savings.

Although the invention is elucidated above with reference to an embodiment, it is not limited thereto. Installation 4 could, for instance, be used to control the atmosphere in several different spaces 1, wherein these spaces 1 can also be filled with different products. The measurements can also be performed more frequently or less frequently than described here, and it is possible to opt for a shorter or longer detection period. Other parameters could further also be measured, such as, for instance, the ethylene content in space 1, which forms an indication of the stage of ripening of the fruit.

The scope of the invention is defined solely by the following claims.

1. A method for controlling the atmosphere in a closable space at least partially filled with agricultural or horticultural products by directly detecting the respiration of the agricultural or horticultural products and adjusting an oxygen content, a carbon dioxide content and/or a nitrogen content in the space subject to the detected respiration, wherein the respiration is detected periodically, in each case for a determined time, and the space is sealed off from external influences during detection of the respiration.

2. The method as claimed in claim 1, wherein the respiration is detected for at least one hour at a time, preferably for several hours.

3. The method as claimed in , claim 1, wherein an adjusting apparatus for the oxygen content, the carbon dioxide content and/or the nitrogen content which is connected to the space is switched off during detection of the respiration.

4. The method as claimed in claim 1, further comprising adjusting means for the temperature connected to the space are switched off during detection of the respiration.

5. The method as claimed in claim 1, wherein the space is made substantially completely leakage-tight, at least during detection of the respiration.

6. The method as claimed in claim 1, the space is brought to a higher pressure than the surrounding area prior to detection of the respiration.

7. The method as claimed in claim 1, wherein the atmosphere in the space is set into or kept in motion during detection of the respiration.

8. The method as claimed in claim 1, wherein days or weeks can pass between successive detections.

9. The method as claimed in claim 1, the respiration of the agricultural or horticultural produce is detected by measuring their oxygen absorption, measuring their carbon dioxide release and determining the ratio thereof, and the oxygen content in the space is decreased as long as the thus determined ratio remains substantially constant.

10. The method as claimed in claim 9, wherein the oxygen content in the space is increased at least temporarily as soon as the ratio of oxygen absorption and carbon dioxide release changes considerably.

11. The method as claimed in claim 9, wherein a detection comprises a number of measurements of the oxygen absorption and carbon dioxide release.

12. An installation for controlling the atmosphere in a closable space at least partially filled with agricultural or horticultural products, comprising:
a controllable apparatus for adjusting an oxygen content, a carbon dioxide content and/or a nitrogen content in the space,
a control system connected to this adjusting apparatus, and
means connected to the control system for directly detecting the respiration of the agricultural or horticultural products, wherein the control system is configured to periodically switch on the respiration detection means for a determined period at a time and to seal off the space from external influences when the respiration detection means are switched on.

13. The installation as claimed in claim 12, wherein the control system is configured to keep the respiration detection means switched on for at least one hour at a time, preferably for several hours in succession.

14. The installation as claimed in , claim 12, wherein the control system is configured to switch off the adjusting apparatus when the respiration detection means are switched on.

15. The installation as claimed in claim 12, wherein the adjusting apparatus further has means for adjusting a pressure in the space and the control system is configured to switch on the pressure adjusting means in order to bring the space to a higher pressure than the surrounding area before the respiration detection means are switched on.

16. The installation as claimed in claim 12, further comprising means for setting the atmosphere in the space into motion, wherein the control system is configured to switch on the moving means when the respiration detection means are switched on.

17. The installation as claimed in claim 12, wherein the control system is configured to switch on the respiration detection means at intervals of several days to several weeks.

18. The installation as claimed in claim 12, the respiration detection means comprise at least one oxygen meter and at least one carbon dioxide meter, and the control system is configured to determine the ratio of a measured oxygen absorption and a measured carbon dioxide release of the agricultural or horticultural produce and to control the adjusting apparatus so as to decrease the oxygen content in the space as long as the thus-determined ratio remains substantially constant.

19. The installation as claimed in claim 18, wherein the control system is configured to control the adjusting apparatus so as to increase the oxygen content in the space at least temporarily as soon as the ratio of oxygen absorption and carbon dioxide release changes considerably.

20. The installation as claimed in claim 18, wherein the at least one oxygen meter and the at least one carbon dioxide meter are configured to perform a number of measurements when the respiration detection means are operating.

21. The installation as claimed in claim 12, wherein the adjusting apparatus further has means for adjusting a temperature in the space.

22. A closable space for storing agricultural or horticultural products in a controlled atmosphere that is provided with an installation as claimed in claim 12, wherein the space is substantially completely leakage-tight, at least when the respiration detection means are operating.

23. The closable space as claimed in claim 22, wherein the space has a leak-tightness of less than 0.2 cm² per 100 m³, preferably less than 0.15 cm² per 100 m³ and more preferably in the order of 0.10 cm² per 100 m³.
